(19) United States
(12) Patent Application Publication
(10) Pub. No.: US 2004/0031234 A1
(43) Pub. Date: Feb. 19, 2004

(54) Window element

(76) Inventor: Thomas Emde, frankfurt (DE)

Correspondence Address: HOFFMAN WASSON & GITLER, 2361 JEFFERSON DAVIS HIGHWAY, SUITE 522, ARLINGTON, VA, 22202

(21) Appl. No.: 10/450,443

(22) PCT Filed: Dec. 20, 2001
(86) PCT No.: PCT/EP01/15101

(30) Foreign Application Priority Data
Dec. 22, 2000 (DE) 10064742.1

(51) Int. Cl. E04H 14/00; E04F 19/00; F21V 7/04; F21S 8/00; E04C 2/54

(52) U.S. Cl. 52/786.11; 52/786.13; 52/28; 362/31; 362/145

(57) ABSTRACT

Window element comprising a frame structure (110) that encloses at least two glass panels (100, 101) spaced from one another, wherein an intermediate space (103) is defined by the distance between the two glass panels, wherein a lighting device with at least one lighting means (102) is provided, said lighting device being arranged in the area of the frame structure and irradiating light essentially from the front surface, this light being at least partly deflected approximately perpendicular to this direction of irradiation, so that said light falls inwards and/or outwards through one of the glass panels of the window element, whereby at least one of the glass panels acts as a light diffuser and for that purpose said glass panel is printed, sand-blasted, etched, coated, engraved or stuck at least on one side or has a malstructure inside, whereby the lighting means is arranged at least partly in front of the front surface of one of the glass panels and irradiates light into the front surface of at least this glass panel, said light being emitted outwards at least partly over the surface of this glass panel.

The present invention relates to a window element comprising a frame structure that encloses at least two glass panels spaced from one another, wherein an intermediate space is defined by the distance between the two glass panels, wherein a lighting device with at least one lighting means is provided, said lighting device being arranged in the area of the frame structure and irradiating light essentially from the front surface, this light being at least partly deflected approximately perpendicular to this direction of irradiation, so that said light falls inwards and/or outwards through one of the glass panels of the window element, whereby at least one of the glass panels acts as a light diffuser and for that purpose said glass panel is printed, sand-blasted, etched, coated, engraved or stuck at least on one side or has a malstructure inside.

A window element of the above-mentioned kind is disclosed in the unpublished DE 200 22 332 1. In principle, this window element represents a kind of insulating window with at least two panels of glass or synthetic glass spaced from each other, wherein the lighting means is arranged in the intermediate space between two panels, so that the light is irradiated from the front surface into this intermediate space. Extensive experiments have shown that, in principle, window elements of this kind can indeed be used as windows, which can be illuminated as required. In this case, the light emitted into the intermediate space from the front surface is also deflected by the light diffusing surface of at least one of the panels in the desired manner and is essentially emitted over the surface of the panel to one side or the other. It has been found, however, that the yield of light and therefore the efficiency of window elements of this kind is not yet optimum.

The object of the present invention consists in providing a window element of the kind mentioned in the introduction, which is fundamentally based on a similar optical principle but which at the same time permits a higher yield of light.

The solution to this problem is provided by a window element according to the invention of the type mentioned in the introduction with the characterising features of the main claim. As part of experiments in conjunction with the present invention, it has been established that a higher yield of light is possible if the light is irradiated directly into the front surface of one of the (glass) panels and not into the intermediate space. As the basic constructional design of an insulating glass window, in which at least two (glass) panels that are separated from each other are enclosed by a frame structure running around the edge region, is to be retained as part of the present invention, the question arises as to where the lighting means are to be accommodated in order to allow irradiation into the front surface of at least one of the glass panels when using a common enclosing frame structure for both glass panels (two or more glass panels can be present). According to a first possible alternative variation of the invention, this problem is preferably solved in such a way that at least one glass panel, into which the lighting means irradiates or irradiate, is designed with a reduced length and/or width dimension compared with at least one further glass panel of the window element. Preferably, the lighting means is then accommodated in the free space between the front surface of the shortened glass panel and the frame structure. By this means, the total of the dimension in the area of the shortened glass panel plus the dimensions of the lighting means can be made approximately equal to the dimension of the un-shortened glass panel. In this way, the lighting means can be situated immediately against the front of the shortened glass panel and yet use a common, simply constructed, enclosing frame structure for the glass panels, which has a straight border so that the frame structure can be accommodated in a conventional slot in a window frame, for example.

Preferably, a frame profile, which is approximately U-shaped in cross section, is used for such a frame structure. Such a frame profile preferably has two legs, each encompassing at least one glass panel, as well as a crosspiece running approximately perpendicular to these two legs and joining them together. The lighting means can then be arranged on the leg of the frame profile. In doing so, the lighting means is/are accommodated either on the transverse or on the longitudinal front surface of at least one of the glass panels. In principle, it would of course be possible to arrange lighting means both on the front surface of the longitudinal side and the transverse side.

In this first variation of the invention, LEDs of different designs, e.g. LED-SMDs or similar, are preferably used as the lighting means, as these lighting means exist in very small types of construction and consume little current. These lighting means can, for example, be arranged in quantity in a row and can be accommodated in a space-saving manner in the frame structure of such a window element.

Furthermore, it is of course possible within the framework of the invention, to irradiate light into the front surface of several glass panels of the window element using lighting means, which are preferably arranged in series. In this case, there are many optical possibilities. For example, the lighting means, which irradiate light into one of the glass panels, can be controlled so that these essentially emit white light and the lighting means, which irradiate light into another glass panel, can be controlled so that these essentially emit coloured light. In this case, white light can be emitted from the window element over its surface essentially to one side of the window element and coloured light can be emitted to the other side, e.g. white light inwards and coloured light outwards (or vice versa), when the window element is one, which, like a conventional window, is installed in the outside wall of a building. In this case, the window element with its internal surface, which faces the room, serves to illuminate the room or to support the room lighting and, at the same time, coloured light is emitted outwards so that the window appears to be coloured and produces a decorative effect. Further possibilities are provided by the fact that the colour of the light of the lighting means used can be varied at will by means of suitable control elements. LEDs of different designs, e.g. LED-SMDs or similar, which allow appropriate control, are used as the lighting means. Furthermore, these lighting means have the advantage that they can be accommodated in a relatively small available space between the front surface of one of the glass panels and the frame structure. Also, these lighting means have the advantage that they have only a small energy consumption compared with conventional lighting means such as fluorescent lamps, filament lamps or the like, as well as a very long life. In addition, these lighting means are virtually maintenance-free.

When glass panels are discussed as part of the present invention, then this is to be understood in such a way that the panels are made either of pure glass, preferably clear glass, or of synthetic glass. Suitable synthetic materials are, for example, polyacryl, polymethacryl or synthetic materials with similar characteristics, which are suitable as fibre-optic conductors and which should have low light absorption.

According to the invention, control devices are preferably used for the lighting means in order to vary these not only in colour but also, for example, dependent upon the incident daylight (dimmer function) and/or dependent on a person present in or approaching the room (by means of movement sensors or the like) or according to an arbitrarily specified programme (e.g. dependent on the time of day).

In order to produce the desired light-diffusing effect over the surface of the glass panels and the deflection of the light, a punctual grid, line grid or similar grid is preferably used, which is applied to at least one side of at least one of the glass panels and which can be printed or stuck or can be achieved by etching, sand-blasting, coating or engraving. As an alternative to achieving the light-diffusing effect in the area of one of the surfaces of one of the glass panels, a malstructure can also be produced in defined areas inside the glass panels, for example by appropriately focused laser irradiation. The emission of diffused light over the surface of the glass panel is also achieved by this means.

According to a second possible alternative variation of the invention, the lighting means are intended to be cast into a kind of strip or printed circuit board. Again, LEDs of different designs, e.g. LED-SMDs or similar light emitting diodes, are preferably used, which can, for example, be cast into a transparent plastic. Such a slat-shaped strip containing the lighting means can have a flat, compact, rectangular block shape and likewise enables the lighting means to be accommodated in an extremely space-saving manner. It has a further advantage that the lighting means are accommodated so that they are watertight and protected against the effects of the weather and mechanical influences. Furthermore, such a lighting strip can be quickly changed, if necessary, in the case of faults, thus saving fitting costs. Access to the lighting strip can take place from the frame structure by removing or opening a frame profile for example.

Such a lighting strip (LED strip) can be wider than the front surface of one of the glass panels. It can also extend, for example, over at least two front surfaces of two glass panels and the intermediate space, which defines the distance between these. With such a constructive solution, unlike the variation described above, it is than unnecessary to design one of the glass panels with a reduced length or width dimension and the lighting strip can be arranged underneath the front surface of the glass panels, i.e. between these glass panels and the frame structure. At the same time, it is unnecessary to irradiate light into both glass panels. Rather, the lighting means can either be introduced into the lighting strip on just one side so that they irradiate only into the front surface of one glass panel. Alternatively, lighting means are arranged in the strip underneath the respective front surfaces of both glass panels and these are switched on as required so that light can feed into the front surface of only one of the glass panels or both glass panels as required.

The above-mentioned lighting strip is preferably a printed circuit board equipped with LEDs of different designs or similar light emitting diodes, in the case of which the lighting means are cast in a transparent material and are protected by this. With this variation of the invention, the lighting strip and the respective ends of at least two glass panels are also preferably enclosed by a frame structure, which, as a rule, comprises a frame profile. This frame profile can be designed to be approximately U-shaped in cross-section and can comprise one of the cross pieces forming the front surface of the frame structure and two legs enclosing the ends of the glass panels. The casting-in process of the LEDs can also be carried out directly in the frame profile. This enables a more accurate positioning and better fixing of the lighting means and simplifies a possible replacement. The glass panels can in turn be made of pure glass or of synthetic glass. The intermediate space between the two or more glass panels is preferably defined by a spacing element, which is arranged between these so that, as a rule, the lighting strip lies underneath the front surfaces of the glass panels and underneath the spacing element.

The characteristics mentioned in the sub-claims relate to preferred improvements of the solution of the problem according to the invention. Further advantages of the invention can be seen from the following detailed description.

The present invention is described in more detail below based on exemplary embodiments with reference to the attached drawings. Here,

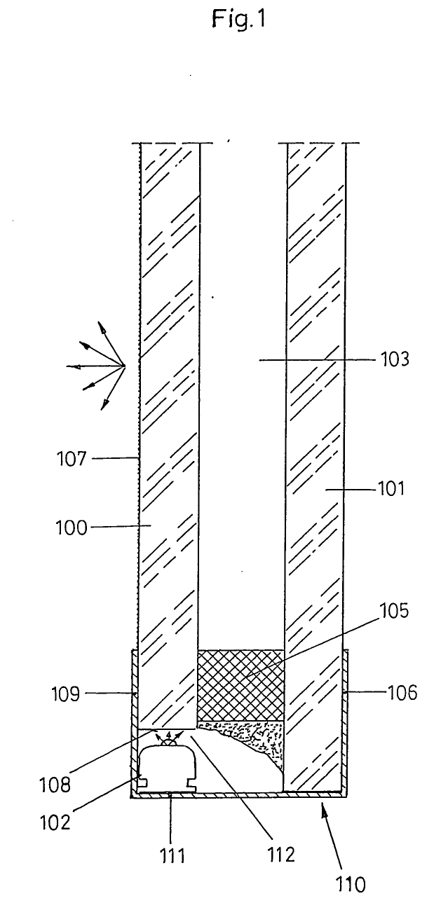

FIG. 1 shows a schematically simplified partial section in the longitudinal direction through a window element according to a first variation according to the invention;

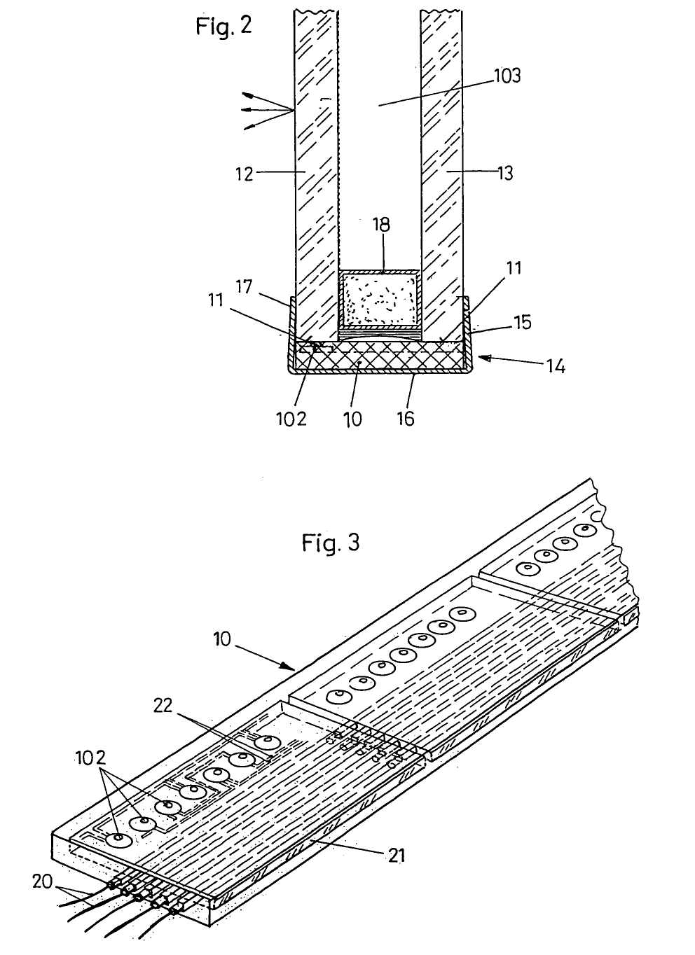

FIG. 2 shows a similar schematically simplified longitudinal section through a window element according to a second variation of the invention;

FIG. 3 shows a perspective view of a lighting strip according to the invention.

Reference is first made to FIG. 1. The drawing shows, schematically simplified, a partial section in the longitudinal direction through a window element according to the invention. In principle, it can be seen that this has two panels 100, 101 made from glass or synthetic glass, which are arranged at a defined distance from one another so that there is an intermediate space 103 between the two panels, as in an insulating glass window. There can also be three or more panels present (such as, for example, with triple glazing). Air under normal pressure or a gas with good sound absorbing characteristics, e.g. argon, can be present in the intermediate space 103. A spacer construction 105, which, as a rule, has additional sealing functions, is used as a spacer in the edge area of both panels 100, 101 or a separate sealing compound is provided.

As can be seen from the drawing, with this exemplary embodiment, one of the glass panels 100, 101 is designed to be shorter in at least one direction of expansion (longitudinal or transverse direction) compared with the other glass panel 101. As a result of this, there is a space 112 between the front surface 108 of this glass panel 100 and the frame structure 110. The lighting means 102 is/are accommodated in the area of this space 112. As a rule, this constitutes a row of LEDs or similar, which are arranged on a slat-shaped arrangement next to one another or behind one another (viewed in the depth of the drawing plane). These lighting means 102 irradiate their light immediately over the front surface 108 into the glass panel 100, within which the light is guided and then at least partially deflected approximately at right angles. This light-deflecting, light-diffusing action is achieved by printing the glass panel 100, in this case on its external surface, with a punctual grid 107, for example, or other textures for deflecting so that the light is emitted as diffused light over the surface of the glass panel as indicated by the arrows in FIG. 1.

An approximately U-shaped frame profile with a crosspiece 111 and two legs 108, 109 approximately perpendicular to this, which lie against the glass panels on the outside, is used as a frame structure 110 for enclosing the two glass panels 100, 101.

A further variation of a window element according to the invention is described below with reference to FIGS. 2 and 3. FIG. 2 shows a schematically simplified partial section in the longitudinal direction through the lower part of a window element according to the invention. Two glass panels 12, 13 are provided, which can be made of pure glass or of synthetic glass. An intermediate space 103 between the two glass panels 12, 13 is defined by a spacer element 18. The spacer element 18 has an extended rectangular shape, for example, and thus a rectangular cross section. As can be seen, a frame structure 14 is again provided, which closes the bottom ends of both glass panels 12, 13 as well as a lighting strip 10 with a flat, rectangular cross section. The frame profile 14 has an approximate U-shape with two legs 17, 15, which each lie against the outside of one of the glass panels 12, 13 and enclose these, and with a cross piece 16, which connects the two legs 17, 15 and which runs parallel to and at a distance from the two front surfaces 11 of the two glass panels 12, 13. The lighting strip 10 is arranged between the front surfaces 11 of the two glass panels and the cross piece 16. In the present exemplary embodiment, the lighting strip 16 is designed so that LEDs are arranged on only one side underneath the front surface 11 of one of the two glass panels 12 so that these lighting means emit their light into the front surface of the glass panel 12. Due to the fact that one of the surfaces of the glass panel 12, for example, is printed with a punctual grid, the light is emitted outwards over the surface of the glass panel 12 in the direction of the arrow in FIG. 2. The LEDs 102 are cast into the LED strip 10, which is made from transparent material, and, as a result, are protected against the effects of the weather. Further LEDs could also be arranged where the front surface 11 of the second glass panel 13 is situated so that there would also be the possibility of irradiating light here onto the front surface as required. In doing so, the lighting means could be controlled so that optionally only one or other of the rows of lighting means is switched on or, if required, the lighting means could be controlled so that either white light or coloured light in possibly different or changing colours is emitted. By this means, it is possible to produce a coloured lighting effect and to vary the colour of the light emitted inwards or outwards from the window element. The brightness can also be varied by appropriate control of the lighting means.

FIG. 3 shows by way of example an enlarged perspective representation of an LED strip 10, such as can be used in the exemplary embodiment for the window element according to FIG. 2. It can be seen that the lighting strip (LED strip) 10 is relatively flat and has an extended rectangular shape. As a result of this, the installed height is very low. The lighting strip 10 is made of a transparent plastic material into which the lighting means 102 and the necessary supply leads 20 are cast. The lighting means 102 are situated on a kind of printed circuit board 21 and, as a rule, printed circuits are provided with conducting tracks 22, which lead to the individual lighting means 102 (light emitting diodes). The lighting means 102 can be arranged in rows, which, as can be seen in FIG. 3, can be combined into groups. As a rule, each lighting means can be activated electronically. The whole printed circuit board 21 is cast into a transparent plastic block from the front of which the cables 20 for the main supply lead can emerge. As a result of this, it is possible to connect and, if necessary, to replace such a lighting strip according to FIG. 3 in a window element according to FIG. 2 very easily and quickly.

1. Window element comprising a frame structure that encloses at least two glass panels spaced from one another, wherein an intermediate space is defined by the distance between the two glass panels, wherein a lighting device with at least one lighting means is provided, said lighting device being arranged in the area of the frame structure and irradiating light essentially from the front surface, this light being at least partly deflected approximately perpendicular to this direction of irradiation, so that said light falls inwards and/or outwards through one of the glass panels of the window element, whereby at least one of the glass panels acts as a light diffuser wherein the lighting means is arranged at least partly in front of the front surface of one of the glass panels and irradiates light into the front surface of at least this glass panel, said light being emitted outwards at least partly over the surface of this glass panel, wherein at least one of the glass panels acts as a light diffuser because said glass panel is printed, sandblasted, etched, coated, engraved or stuck at least on one side,
wherein LEDs, LED-SMDs, other light emitting diodes or similar, which are arranged on the front side of the frame structure, are used as the lighting means wherein the window element has the basic constructional design of an insulating glass window, in which at least two (glass) panels (100, 102, 12, 13) separated from each other are enclosed by a frame structure (110, 14) running around the edge region, air or a gas with good sound absorbing characteristics can be present in the intermediate space (103), a spacer construction (105, 18), which has additional sealing functions, is used as a spacer in the edge area of both panels (100, 101, 12, 13) or a separate sealing compound is provided.

2. Window element according to claim 1, characterised in that the glass panel (100), into which the lighting means (102) irradiates, has a reduced length and/or width dimension compared with at least one further glass panel (101) of the window element.

3. Window element according to claim 1 or 2, characterised in that the lighting means (102) is arranged in the free space (112) between the front surface (108) of the shortened glass panel (100) and the frame structure (110).

4. Window element according to one of claims 1 to 3, characterised in that the frame structure (110) is a frame profile, which is essentially U-shaped in cross-section.

5. Window element according to one of claims 1 to 4, characterised in that the frame structure (110) has a frame profile with two legs (109, 106), each enclosing at least one glass panel (100 or 101), as well as a crosspiece (111) running approximately perpendicular to these two legs and joining them together.

6. Window element according to one of claims 1 to 5, characterised in that the lighting means (102) is/are arranged on the cross piece (111) of the frame profile.

7. Window element according to one of claims 1 to 6, characterised in that one of the glass panels (101) essentially extends as far as the crosspiece (111) of the frame profile (110) while at least one further glass panel (100) ends with a space before this crosspiece (111).

8. Window element according to one of claims 1 to 7, characterised in that an LED strip (printed circuit board) (10), in which LEDs or LED-SMDs are cast, is used for the lighting means.

9. Window element according to one of claims 1 to 8, characterised in that the LED strip (10) is wider than the front surface (11) of one of the glass panels (12).

10. Window element according to one of claims 1 or 9, characterised in that the LED strip (10) is of such a width that it covers at least two front surfaces of two glass panels (12, 13) and that the light is irradiated into the front surface of at least one of the glass panels or into two glass panels (13) simultaneously by means of one LED strip (10).

11. Window element according to one of claims 1 to 10, characterised in that the LED strip (10) comprises a printed circuit board equipped with LEDs, which is cast in a transparent material.

12. Window element according to one of claims 1 to 11, characterised in that the LED strip and the respective ends of at least two glass panels (12, 13) are enclosed by a frame structure comprising a frame profile (14).

13. Window element according to one of claims 1 to 12, characterised in that the frame profile (14) is designed to be approximately U-shaped in cross-section and comprises a crosspiece (16), which forms the front surface of the frame structure, and two legs (15, 17), which enclose the ends of the glass panels (12, 13).

14. Window element according to one of claims 1 to 13, characterised in that the LED strip (10) is arranged between the frame profile (14) and the front surfaces (11) of at least two glass panels (12, 13).

15. Window element according to one of claims 1 to 14, characterised in that one or more of the glass panels (100, 101) is made of pure glass or of synthetic glass.

16. Window element according to one of claims 1 to 15, characterised in that control devices are provided for the lighting means (102) in order to control these in such a way that the lighting means emit white or coloured light as required.

17. Window element according to one of claims 1 to 16, characterised in that a first quantity of lighting means (102) is provided, which emits coloured or white light, and at least one quantity of second or further lighting means is provided, which emit different coloured light compared with the first quantity of lighting means (102).

18. Window element according to one of claims 1 to 17, characterised in that control devices and/or sensors are provided, which control the lighting means (102) dependent upon incident daylight, dependent on a person present in or approaching the room or according to an arbitrarily specified programme.

19. Window element according to one of claims 1 to 18, characterised in that, in order to produce the light-diffusing effect, at least one of the glass panels has a punctual grid, line grid or similar grid printed, sand-blasted, etched, coated, engraved or stuck on at least one side.

20. Window element according to one of claims 1 to 19, characterised in that at least one glass panel (100) has a malstructure inside in defined areas produced by laser irradiation for producing a light-diffusing effect with the emission of diffused light over the surface of the glass panel.
